(19) United States
(12) Patent Application Publication
(10) Pub. No.: US 2011/0181436 A1
(43) Pub. Date: Jul. 28, 2011

(54) COMMUNICATIONS CONNECTION IN A SUBSEA WELL

(76) Inventors: Peter John Davey, North Somerset (GB); Ian Kent, Bristol (GB)

(21) Appl. No.: 13/009,512

(22) Filed: Jan. 19, 2011

(30) Foreign Application Priority Data
Jan. 21, 2010 (GB) 1000964.5

(51) Int. Cl. G01V 3/00

(52) U.S. Cl. 340/854.7

(57) ABSTRACT

A communication connection in a subsea well for converting an optical signal from an optical fiber to an electrical signal, comprising a small form factor pluggable device.

### BACKGROUND OF THE INVENTION

1. Field of the Invention

The present invention relates to a communications connection in a subsea well.

2. Description of Related Art

Subsea wells, such as hydrocarbon extraction wells, are typically supplied with hydraulic and electrical power and communications via an umbilical from a surface platform or surface vessel. Modern wells use optical fibers for communication to the umbilical as they are able to handle the higher bandwidths required. The umbilical is typically terminated in an umbilical termination assembly (UTA) whereby power and communications are distributed to the multiplicity of well trees typical of a subsea well complex, for example either directly or via one or more subsea distribution units. Communication from the UTA can be via fiber optics and/or copper in dependence on a combination of the bandwidth requirements and distances of the individual well trees from the UTA. Termination of the optical fibers from the umbilical is effected by fiber optic connectors, typically as many as at least six being required, with linking of the UTA outputs to the well trees requiring further connectors. The problem is that optical fiber connectors suitable for the high water pressure environment of subsea wells are expensive and typically do not have the confidence of well operators as much as well-established electrical connectors. This invention removes the need for fiber optic connectors.

### BRIEF DESCRIPTION OF THE INVENTION

According to the present invention from one aspect, there is provided a communication connection in a subsea well for converting an optical signal from an optic fiber to an electrical signal, comprising a small form factor pluggable device.

According to the present invention from another aspect there is provided a method of providing a communication connection in a subsea well for converting an optical signal from an optical fiber to an electrical signal, comprising using a small form factor pluggable device to convert the optical signal to an electrical signal.

The connection could be between said optical fiber and a subsea electronics module at a well tree or at an underwater termination assembly or at a subsea distribution unit for example.

Said fiber is typically in an umbilical.

There could be a further small form factor pluggable device coupled with the first small form factor pluggable device for converting said electrical signal to an optical signal.

Each small form factor pluggable device could be received in an electrical connector. In this case, the connector could comprise first and second mated parts, each having a respective shell portion, each small form factor pluggable device being received in a respective one of the shells.

Where the connection is between said optical fiber and a subsea electronics module, power for each small form factor pluggable device could be provided from the subsea electronics module.

Alternatively, power for each small form factor pluggable device could be provided by electrical power supplied from a surface facility or by optical energy from a further optical fiber or by a rechargeable battery.

### BRIEF DESCRIPTION OF THE DRAWINGS

FIG. 1 shows diagrammatically the termination of an umbilical at a UTA, together with a well tree coupled with the UTA;

FIGS. 2a-2c show a first set of embodiments of the invention; and

FIGS. 3a-3c show a second set of embodiments of the invention.

### DETAILED DESCRIPTION OF THE INVENTION

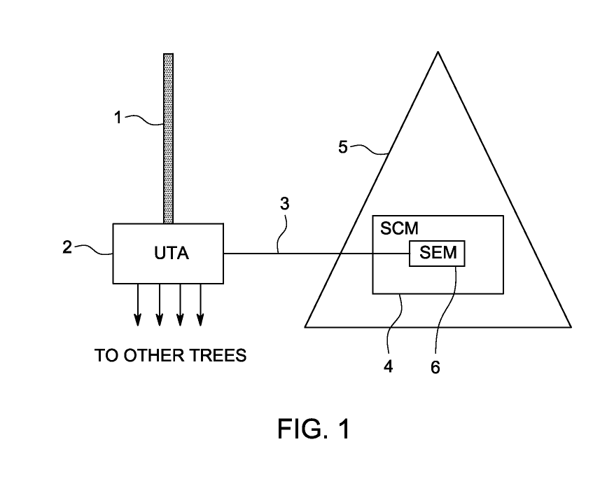

FIG. 1 shows a typical arrangement of the termination of an umbilical 1 from a surface facility such as a surface platform or surface vessel at UTA 2, the output 3 of which feeds hydraulic power to a subsea control module (SCM) 4 mounted on a well tree 5 and feeds electrical power and communication to a subsea electronic module (SEM) 6 housed in the SCM 4. The UTA 2 also feeds hydraulic and electrical power and communications to other trees in a well complex.

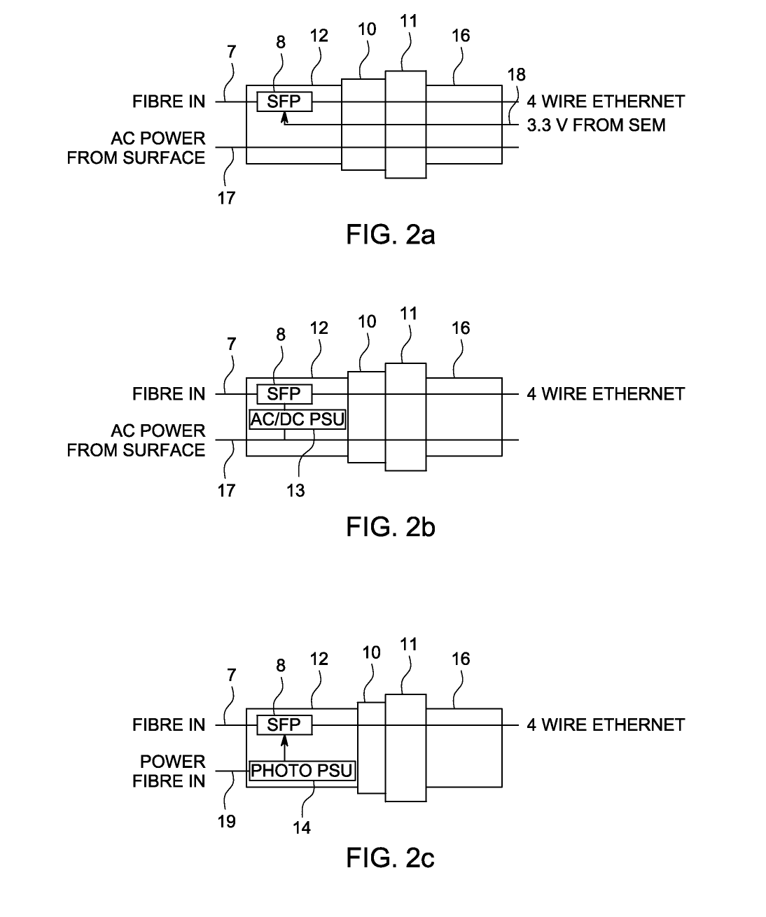

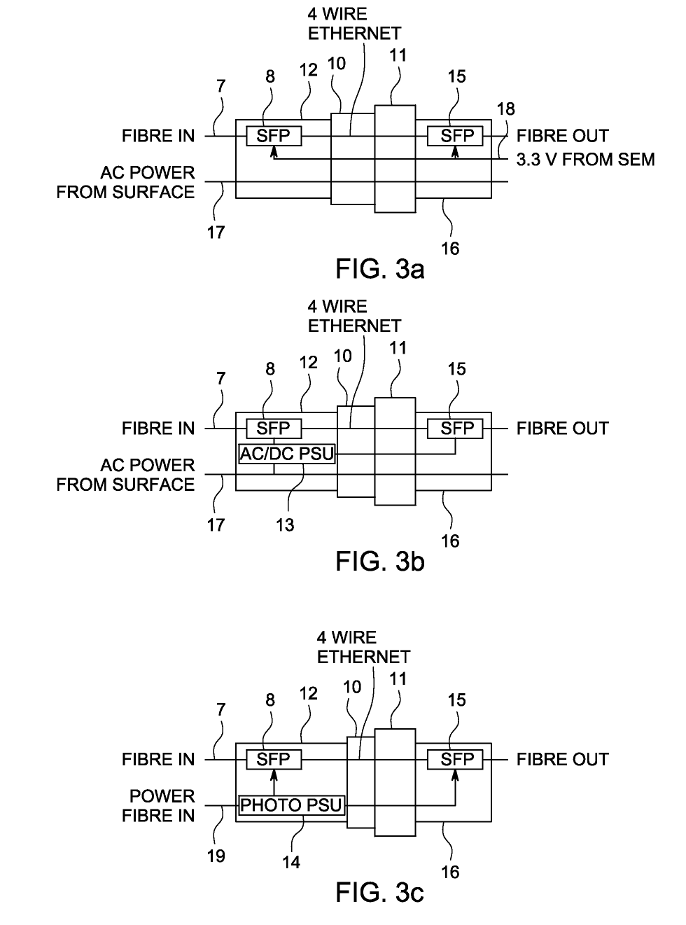

In FIGS. 2a-2c and 3a-3c, reference numeral 7 denotes an optical fiber in an umbilical from a UTA, reference numeral 8 designates a small form factor pluggable device (SFP) at which the fiber 7 terminates and reference numerals 10 and 11 designate two mated together parts of a copper connector having end shells 12 and 16 respectively, the SFP 8 being mounted in and molded into the end shell 12 of the connector part 10.

FIG. 2a shows an arrangement according to the invention where the required communication interface to the SEM is copper, such as 4-wire Ethernet, reference numeral 17 designating a line carrying AC power from the umbilical from the surface facility. SFPs suitable for the invention are available off the shelf Electric power is required for the SFP 8, typically at 3.3 volts. This can be provided from the DC power supplies already available in the SEM via a line 18. Alternatively, since the power requirements of the SFP 8 are small, an alternative power source, as shown in FIG. 2b, is practical in which a small AC to DC power supply unit 13, such as a switching or capacitor fed power supply, deriving power from the AC power on line 17 is also mounted in the end shell 12. This arrangement saves two connections through the connector 10/11, which can result in significant cost reduction. A further alternative way of providing electric power to the SFP 8 (particularly if there are spare optical fibers in the umbilical from the UTA and as illustrated in FIG. 2c) is to transmit light down a fiber 19 and utilize a photovoltaic cell to convert the light to electrical power to supply the SFP, i.e. a photovoltaic power supply unit 14, which can also be molded in the end shell 12 of the connector 10/11. The light typically would be provided via the umbilical from the surface facility to the UTA.

FIGS. 3a-3c show modifications of the embodiments of FIGS. 2a-2c respectively where the required communication interface to the SEM is optical fiber. In FIG. 3a, an SFP 15 is also mounted in and molded in the end shell 16 of connector part 11 of the mated copper connector 10/11. The SFP 8 converts the fiber optic output to an electrical interface, such as 4-wire Ethernet, which feeds through the copper connector 10/11 to the SFP 15 which converts the electrical interface back to a fiber optic one. Thus, an electrical connector can be used to achieve the interface instead of a much more expensive optical fiber connector. The short length of copper in the connector 10/11 allows data rates of up to 100 Mbits/second, which is adequate for most subsea well applications and typically matches the fiber optic achievable bandwidth. Electrical power for the SFPs 8 and 15 is provided (as in FIG. 2a) from existing power supplies in the SEM. FIG. 3b shows an arrangement in which electric power is supplied to the SFPs 8 and 15 by a small power supply unit as in FIG. 2b and FIG. 3c shows the power supply derived from a photovoltaic cell 14 energized by light via a spare optical fiber as in FIG. 2c.

The present invention may be applied not just to an optical fiber connection at a well tree, but also to an optical fiber connection at a UTA (e.g. from an umbilical from a surface facility or out of the UTA) and/or into or out of a subsea distribution unit. Also, the invention is not restricted to the use of 4-wire Ethernet—it may be applied, for example, to any form of serial communications.

A further alternative to the forms of power supply for each SFP is to use a rechargeable battery, for example a battery rechargeable using light from an optical fiber.

Expensive fiber optic connectors are eliminated and replaced by much cheaper electrical connectors.

Many modern wells and their SEMs employ Ethernet interfaces. This invention provides a neat and low cost direct conversion from the fiber optic output of the umbilical to the Ethernet communication system.

What is claimed is:

1. A communication connection in a subsea well for converting an optical signal from an optical fiber to an electrical signal, comprising a small form factor pluggable device.

2. The communication connection of claim 1, wherein the communication connection is between the optical fiber and a subsea electronics module at a well tree or is at an underwater termination assembly or is at a subsea distribution unit.

3. The communication connection of claim 1, wherein the optical fiber is in an umbilical.

4. The communication connection of claim 1, comprising an additional small form factor pluggable device coupled with the small form factor pluggable device for converting the electrical signal to an optical signal.

5. The communication connection of claim 1, wherein the small form factor pluggable device is received in an electrical connector.

6. The communication connection of claim 5, wherein the electrical connector comprises first and second mated parts, each having a respective shell portion, the small form factor pluggable device being received in a respective one of the shells.

7. The communication connection of claim 4, wherein each small form factor pluggable device is received in an electrical connector.

8. The communication connection of claim 7, wherein the electrical connector comprises first and second mated parts, each having a respective shell portion, and wherein each small form factor pluggable device being received in a respective one of the shells.

9. The communication connection of claim 2, wherein:
the communication connection is between the optical fiber and the subsea electronics module; and
power for the small form factor pluggable device is provided from the subsea electronics module.

10. The communication connection of claim 1, wherein power for the small form factor pluggable device is provided by electrical power supplied from a surface facility or is provided by optical energy from a further optical fiber or is provided by a rechargeable battery.

11. A method of providing a communication connection in a subsea well for converting an optical signal from an optical fiber to an electrical signal, comprising converting the optical signal to an electrical signal using a small form factor pluggable device.

12. The method of claim 11, wherein the communication connection is between
the optical fiber and a subsea electronics module at a well tree; or
is at an underwater termination assembly; or
is at a subsea distribution unit.

13. The method of claim 11, wherein the optical fiber is in an umbilical.

14. The method of claim 11, further comprising providing a further small form factor pluggable device coupled with the first small form factor pluggable device to convert the electrical signal to an optical signal.

15. The method of claim 11, wherein the small form factor pluggable device is received in an electrical connector.

16. The method of claim 15, wherein the electrical connector comprises first and second mated parts, each having a respective shell portion, the small form factor pluggable device being received in a respective one of the shells.

17. The method of claim 14, wherein each small form factor pluggable device is received in an electrical connector.

18. The method of claim 17, wherein the electrical connector comprises first and second mated parts, each having a respective shell portion, and wherein each small form factor pluggable device being received in a respective one of the shells.

19. The method of claim 12, wherein the connection is between the optical fiber and a subsea electronics module and power for the small form factor pluggable device is provided from the subsea electronics module.

20. The method of claim 11, wherein power for the small form factor pluggable device is provided by electrical power supplied from a surface facility or is provided by optical energy from a further optical fiber or is provided by a rechargeable battery.
